(19) United States
(12) Patent Application Publication
(10) Pub. No.: US 2022/0295974 A1
(43) Pub. Date: Sep. 22, 2022

(54) INTERCHANGEABLE PAINTING SYSTEM

(71) Applicant: Ameer Akbar, Providence, RI (US)

(72) Inventor: Ameer Akbar, Providence, RI (US)

(21) Appl. No.: 17/527,262

(22) Filed: Nov. 16, 2021

Related U.S. Application Data
(60) Provisional application No. 63/114,006, filed on Nov. 16, 2020.

(51) Int. Cl. A46B 5/00; A46B 15/00; A46B 17/06; B44D 3/12

(52) U.S. Cl. CPC A46B 5/0095; A46B 5/005; A46B 15/0026; A46B 17/06; B44D 3/121; B44D 3/128; A46B 2200/202

(57) ABSTRACT

An interchangeable painting system is disclosed. The interchangeable painting system includes a painting object including a shaft and at least part of the painting object is configured to apply paint to a surface and a handle including a body with a receptacle that is configured to receive the shaft of the painting object; and a latch attached to the body and configured to reversibly engage the shaft of the painting object such that the painting object is secured to the handle when the latch is in a first position and released from the handle when the latch is in a second position.

### CLAIM OF PRIORITY

This application claims priority to U.S. Patent Application Ser. No. 63/114,006, filed on Nov. 16, 2020, the entire contents of which are hereby incorporated by reference.

### TECHNICAL FIELD

This disclosure relates interchangeable painting systems including paint brushes, extension handles, and paint containers.

### BACKGROUND

Painters require tools that allow them to work more effectively and efficiently. Painting a large area or building is a time intensive task and managing a crew adds to the complexity of the task. Furthermore, these large painting jobs require a collection of painting tools that are cumbersome to manage and clean. At the end of each day, there can be dozens of painting tools to clean.

Currently, when a painter needs to change from a large brush to a small brush, the painter needs to find the small brush, set aside the large brush, and continue painting. If the small brush is not nearby, time is wasted fetching the small brush. When the painter needs to change from the small brush to a roller, the same process is followed. Setting aside a brush only to need it again in a few hours will require it to be cleaned before reuse. These incremental tasks add time and cost to the painting project.

### SUMMARY

An interchangeable painting system provides a simply way for a painter to replace a first brush on a paintbrush handle with a second paintbrush brush on the same handle and continue painting. For example, when cutting (i.e., painting or detailing) a wall and realizing a 3.5 inch brush doesn't fit, the painter can remove the brush with one click, attach a 2.5 inch brush on same paintbrush handle and continue painting. For example, the size of brush, the angled sash, and the bristles can be changed with ease. In addition to various size brushes, various size rollers can also be attached to the paintbrush handle. For example, a roller can be attached to easily paint a larger area than a brush could reasonably handle. The paintbrush handle can also be attached to an extension handle with a telescoping pole to paint ceilings or other hard-to-reach locations.

The interchangeable painting system also includes a paint container with several reservoirs for paint. Each reservoir includes magnets so the painter can attach the brushes they expect to need for a given job in the bucket attached to the magnets. When the painter needs to change the brush, the painter can insert the paintbrush handle with a brush into one reservoir, press a button to detach the brush, move the paintbrush handle to a different reservoir and attach it to a different brush. Each reservoir can contain different paint so the painter can easily switch paint color and brushes quickly.

The interchangeable painting system is also part of a recycling program for painters to promote recycling and reduce waste. A painter could subscribe to the recycling program to receive discounts on brushes and rollers compatible with the interchangeable painting system by encourage the painters to recycle their old or damaged painting equipment.

In an aspect, an interchangeable painting system include a painting object including a shaft and at least part of the painting object is configured to apply paint to a surface. The interchangeable painting system includes a handle including: a body with a receptacle that is configured to receive the shaft of the painting object; and a latch attached to the body and configured to reversibly engage the shaft of the painting object such that the painting object is secured to the handle when the latch is in a first position and released from the handle when the latch is in a second position.

In some interchangeable painting systems, the latch includes a collet configured to radially engage the shaft for securing the painting object in the first position. In some cases, the collet is engagable by rotating a collar of the handle in a first rotational direction and releasable by rotating the collar of the handle in a second rotational direction, the second rotational direction being opposite to the first rotational direction.

In some interchangeable painting systems, the latch includes a ramped portion to radially engage a T-connector of the shaft for securing the painting object in the first position. In some cases, the T-connector is engagable by sliding a collar of the handle along a first longitudinal direction and releasable by sliding a collar of the handle along a second longitudinal direction, the second longitudinal direction being opposite to the first longitudinal direction.

In some interchangeable painting systems, the handle further includes a spring to bias the painting object in a released state from the handle.

In some interchangeable painting systems, the receptacle is located at an end of the handle and the receptacle is concentric with the handle.

In some interchangeable painting systems, the handle further includes a detent configured to releasably engage with a latch of an extension handle such that the detent is engaged when the latch is in a first position and released when the latch is in a second position. In some cases, the latch is spring-loaded such that the latch is biased in the first position. In some cases, the handle is configured to slide within a cylindrical bore of an extension handle such that the handle is covered by the extension handle when the handle is engaged with the extension handle. In some cases, the extension handle includes a telescoping tube telescopically connected to the extension handle and the latch is located at a first end of the telescoping tube.

In some interchangeable painting systems, the painting object is a brush including a plurality of resilient bristles suitable for painting.

In some interchangeable painting systems, the painting object is a roller including a wicking material suitable for painting.

In some interchangeable painting systems, the painting object includes a magnet configured to magnetically attach the handle to a paint container.

Some interchangeable painting systems further include a paint container with at least one reservoir configured to accept at least a portion of the painting object and hold a volume of paint. In some cases, the at least one reservoir includes a magnet within a sidewall of the at least one reservoir. In some cases, the magnet is configured to magnetically attach the painting object to the paint container. In some cases, the at least one reservoir of the paint container includes a magnet configured to magnetically attach the handle to the paint container. In some cases, the paint container includes a grate for removing excess paint from the painting object. In some cases, the at least one reservoir is three reservoirs. In some cases, the volume is at least 0.5 pints.

In an aspect, a handle for an interchangeable painting system includes a latch located at a first end of the handle, the first latch being configured to releasably engage with a shaft of a painting object. The handle includes a detent located in a central area of the handle, the detent being configured to releasably engage with a latch of an extension handle. The handle is configured to orient the painting surface for painting.

In some handles, the latch includes a spring-loaded button configured to disengage the handle from the shaft of the painting object when pressed. In some cases, the spring-loaded button is movable in a direction perpendicular to a longitudinal axis of the handle.

In some handles, the painting object is a brush including a plurality of resilient bristles suitable for painting

In some handles, the painting object is a roller including a wicking material suitable for painting.

In some handles, at least a portion of the handle is configured to slide within a cylindrical bore of an extension handle.

In some handles, at least a portion of the handle is contained within a cylindrical bore of an extension handle when the handle is releasably engaged with the latch of the extension handle.

Some handles further include a magnet configured to releasably attach the handle to a paint container.

In an aspect, an extension handle for an interchangeable painting system includes a telescoping tube telescopically connected to the extension handle. The telescoping tube includes a first latch located at a first end of the telescoping tube and the first latch is configured to releasably engage with a detent of a handle. The extension handle includes a second latch configured to releasably engage one or more openings in the telescoping tube. The telescoping tube is configured to slide within a bore of the extension handle.

In some extension handles, the second latch includes a spring-loaded button configured to release the telescoping tube from the extension handle when pressed.

Some extension handles further include the handle, wherein the handle include a third latch configured to releasably engage with a shaft of a painting object. In some cases, a portion of the handle is configured to slide within the bore of the telescoping tube. In some cases, the extension handle includes a grip configured to orient the painting object for painting.

In an aspect, a paint container for an interchangeable painting system includes one or more reservoirs, each reservoir including a magnet embedded into a sidewall of the reservoir, each magnet configured to releasably attach a painting object to the respective reservoir.

In some paint containers, each reservoir is sized to store at least 0.5 pints of paint.

Some paint containers further include a grate for removing excess paint from the painting object.

Some advantages of the interchangeable painting system are as follows.

By incorporating a collet to quick-release and attach different brushes, the interchangeable painting system is easy to operate. This is advantageous for a painter that may only have one hand available during painting or for users with lower dexterity such as the elderly. For example, the collet can be turned and tightened with a single thumb of the painter while grasping the paintbrush handle with the figures of the same hand. Furthermore, a quick-release button to detach an extension pole from the paintbrush handle allows the system to be used in a one-handed operation. These quick-release connections also allow for a compact connection that does not take up a lot of space on the paint brush.

By incorporating a single paintbrush handle, the painter has simply less to clean at the end of the day. This is particularly advantageous when there is a large crew and each painter is using many brushes.

By removing the brushes from the paintbrush handle, the painter also has less to carry around the job. This is advantageous when a painter may need three paint brushes and a roller to complete a job. The small brushes without a handle can be carried on the painter instead of needing to go locate the other brushes when needed. This is more convenient for the painter and improves the efficiency of the painting job.

By removing the brushes from the paintbrush handle, there is also less waste at the brush's end of life because there is usually no need to dispose of paintbrush handle. This is advantageous from an environmental perspective. There are too many wooden and plastic paint brushes being disposed of and put into our landfills every year.

By establishing a recycling program for painters there is an incentive to recycle parts of the interchangeable painting system. By establishing rebates and discounts on brushes and rollers compatible with the interchangeable painting system, the likelihood of waste is even further reduced.

By combining incorporating the paintbrush handle, various brushes, and a paint container into a kit, a painter would not need to buy individual pieces. This would not only lower the cost to adopt the interchangeable painting system, but it would allow the painter to begin immediately.

By making the interchangeable painting system compatible with other types of brushes, canvass painters and make-up artists, both with hundreds of brushes, could benefit from the interchangeable painting system. One handle for the entire set of brushes would be advantageous.

By making the paint container able to store different paints, the painter can switch brushes and switch paint colors easily. For example, if the painter cannot paint an area because the paint is not dry, the painter can switch to use a different color paint. The painter could start painting with the different color in a different reservoir with the same handle without having to waste time to clean the paint container or use different bucket. This avoids having to keep cleaning brushes, especially knowing that the painter will need to use that color again within a few hours.

For ease of description, terms such as “upper”, “lower”, “top”, “bottom” “left” and “right” are relative to the orientation of the features in the figures rather than implying an absolute direction.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIGS. 1A and 1B illustrate paint brush of an interchangeable paint brush system.

FIGS. 2A and 2B illustrate a roller of the interchangeable paint brush system.

FIGS. 3A and 3B illustrate an extension handle and pole of the interchangeable paint brush system.

FIG. 4 illustrates the extension handle and pole being used with the paint brush of the interchangeable paint brush system.

FIG. 5 illustrates the extension handle and pole being used with the roller of the interchangeable paint brush system.

FIG. 6 illustrates a paint bucket of the interchangeable paint brush system.

Like reference symbols in the various drawings indicate like elements.

### DETAILED DESCRIPTION

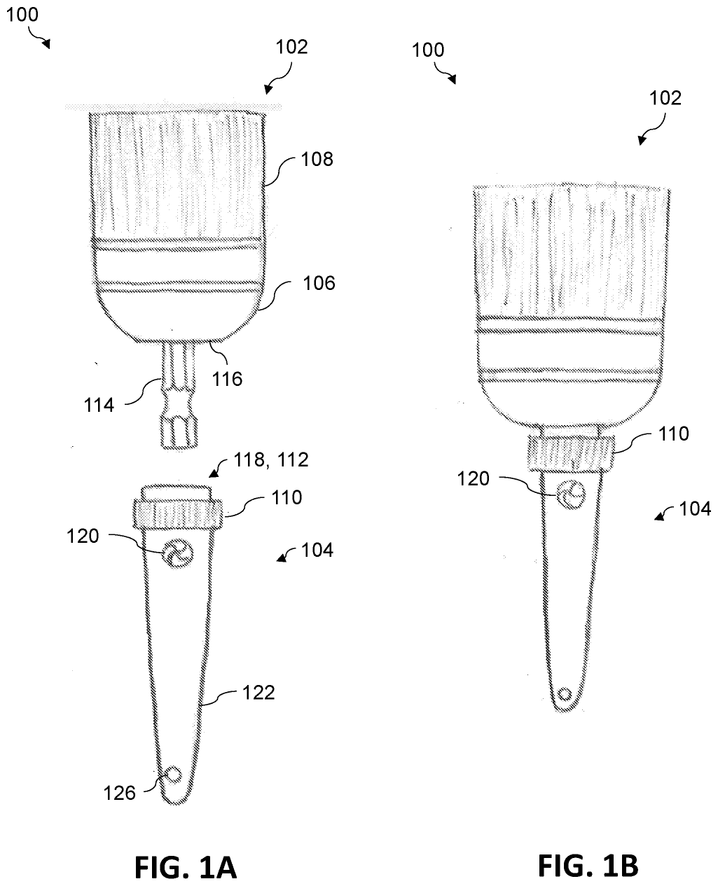

FIGS. 1A and 1B are illustrations of an interchangeable painting system 100. FIG. 1A shows the interchangeable painting system 100 in a detached state. The interchangeable painting system 100 includes a painting object 102. The paining object is shown as a brush 102, but any painting object that retains paint so it can be transferred to a painting surface is usable with the interchangeable painting system 100 (e.g., a wicking brush, a foam brush, a sausage roller, etc.).

As shown, the brush 102 is a 1.5 inch wide flat brush, but other brushes are usable with the interchangeable painting system. For example, 1.5 inch to 4 inch wide brushes of angled and flat sashes are usable with the interchangeable painting system 100. The brush 102 includes a ferrule 106 and resilient bristles 108 suitable for painting. The paintbrush handle 104 is provided for a painter to hold the brush 102 when painting and is configured to mate with interchangeable brushes and an extension handle, as will be described in further detail below.

The paintbrush handle 104 includes a releasable connection 118 (or “T” connection) at a first end of the paintbrush handle 104 that allows the brush 102 to be securely connected to the paintbrush handle 104. In the implementation shown, the releasable connection 118 is a collet connection with a chuck that forms a collar around the shaft 114 of the brush 102. The chuck is rotationally connected to a collar 110 that is rotatable with respect to a longitudinal axis of the shaft 114. The shaft 114 is shown with a hexagonal cross-section that engages the collet to secure the brush 102 to the paintbrush handle 104. However, in some implementations, a smooth cylindrical shaft, or other cross-section shaft (e.g., triangular, square, octagonal, etc.) is used. In some implementations, the shaft 114 is keyed so the painter can only attach the brush 102 in one or two orientations.

When attaching the brush 102 to the paintbrush handle 104, the painter inserts the shaft 114 into a receptacle 112 of the paintbrush handle which houses the collet. A depth of the receptacle 112 is sufficiently deep such that a bottom face 116 of the ferrule 106 rests against a face of the receptacle 112 when the brush 102 is connected to the paintbrush handle 104. This is shown in FIG. 1B. However, in some implementations, the bottom face of the ferrule 106 sticks out by a distance (e.g., quarter inch, half inch, etc.) from the face of the receptacle 112 when the brush 102 is connected to the paintbrush handle 104. To secure the brush 102 to the paintbrush handle 104, the painter turns the collar 110 in a first direction so the collet moves in a radial direction toward the shaft 114 and frictionally engages the shaft 114. The friction exerts a clamping force on the shaft 114 holding the shaft 114 in place. This engagement forms the connection 118. In some implementations, the collet includes a tapered outer collar that engages the shaft 114 to form the connection 118.

FIG. 1B illustrates the interchangeable painting system 100 in the attached state. In the attached state, movements of the paintbrush handle 104 by a painter are coupled to the brush 102 so the painter can paint normally. When the painter wants to remove the brush 102 from the handle 104 (e.g., a different brush is needed, or to clean the parts of the interchangeable painting system 100), the painter turns the collar 110 in a second, opposite, direction so the collet separates from the shaft 114 and so the shaft 114 is again slidable with respect to the paintbrush handle 104.

In some implementations, the receptacle 112 of the paintbrush handle 104 includes a spring to bias the brush 102 in the detached state so that when the collar 110 is rotated in the second direction to release the brush 102, the brush 102 is ejected from the paintbrush handle 104.

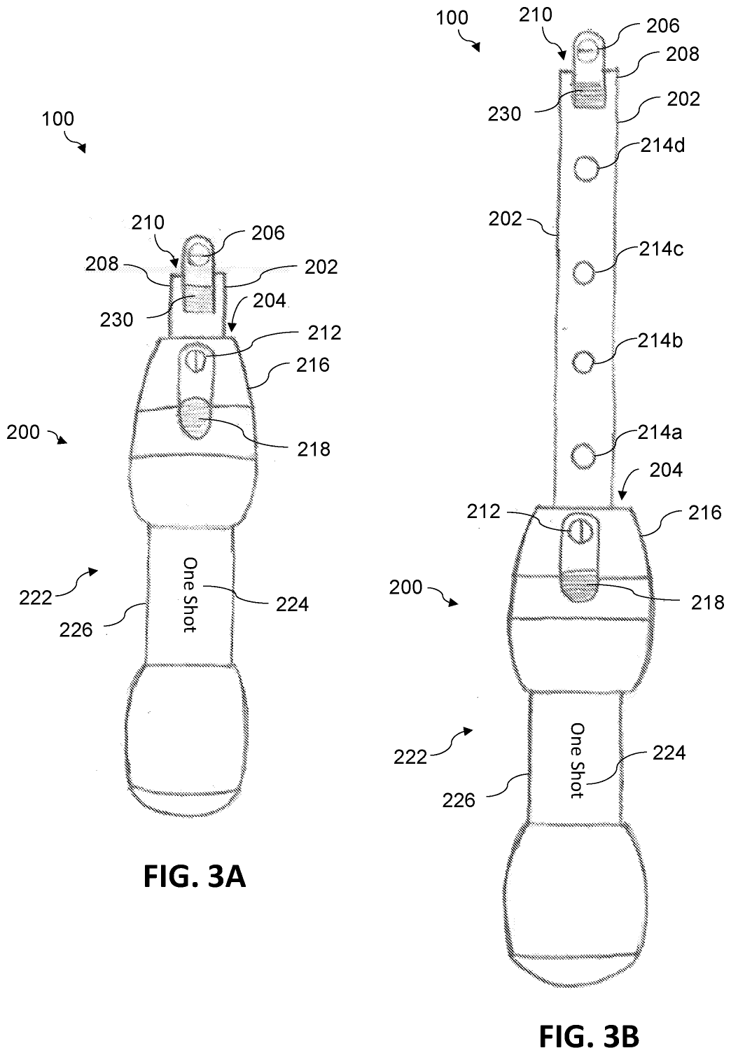

The paintbrush handle 104 also includes a detent 120 (or recess) located in a central area of the paintbrush handle 104 that is configured to releasably engage with a latch of an extension handle that will be described with respect to FIG. 3. The detent 120 is configured to lock the paintbrush handle 104 the extension pole for the use of different tools when the extension pole is needed.

The paintbrush handle 104 also includes a grip 122 located at an opposite end of the brush 102. The grip 122 is used by the painter to operate the brush 102 for painting. The grip 122 is sized such that it is insertable and slidable within a cylindrical bore of an extension handle so that a latch of the extension handle can engage the detent 120 located in a central area 124 of the paintbrush handle 104. When the detent 120 is engaged, the paintbrush handle 104, including any brushes if attached, are securely connected to the extension handle. Additionally, the grip 122 is completely contained within the cylindrical bore of the extension handle 122 and only a portion of the paintbrush handle 122 projects out of an end of the extension handle. The paintbrush handle 104 is shaped so that a diameter of one end of the grip 122 has a smaller diameter than a diameter of the latched end of the paintbrush handle 104.

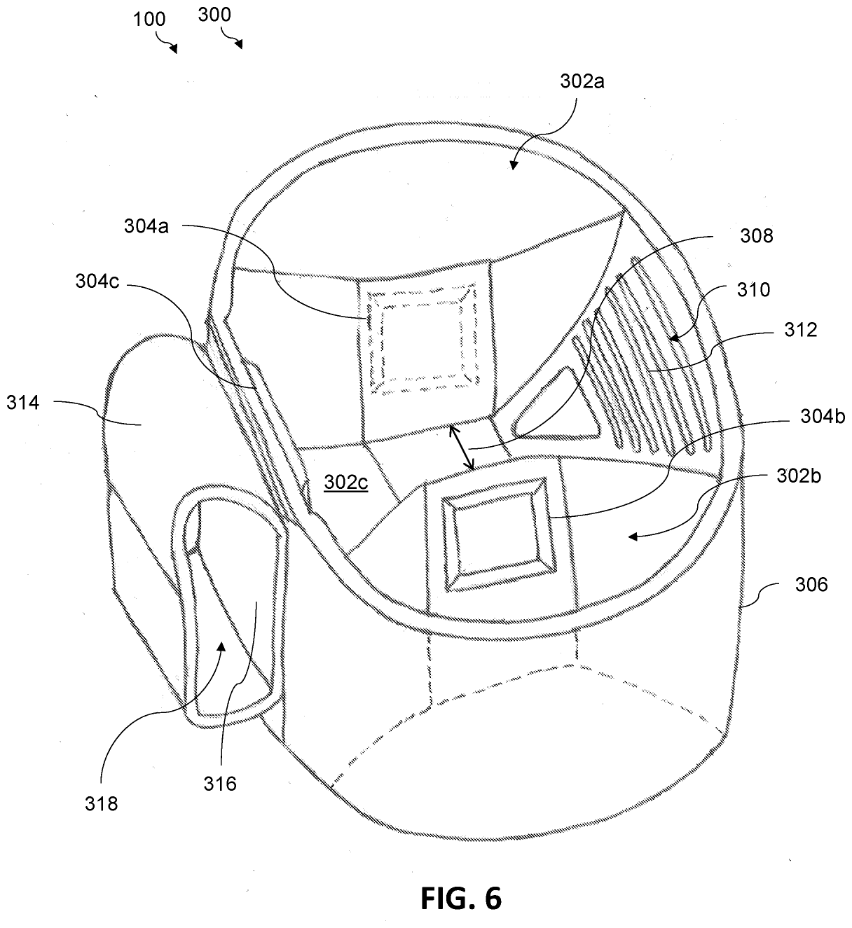

The brush 102 also includes a built-in magnet for attaching the brush 102 to a paint container. In some implementations, the brush ferrule 106 is made of a magnetic material such as materials containing iron (e.g., steel, some stainless steels) or nickel or cobalt. In some implementations, the paintbrush handle 104 includes a built-in magnet for attaching the paintbrush handle to a paint container. In some implementations, at least part of the paintbrush handle is made of a magnetic material. For example, a magnetic paintbrush handle allows the paintbrush to be attached to a paint container when the brush is not being used. This functionality will be described with respect to FIG. 6 later. In some implementations, fabricating the paintbrush handle 104 from magnetic materials and plastic materials allows the paintbrush handle 104 to last a long time (e.g., 10-100 years). Preferably these materials are structurally strong, lightweight, and durable.

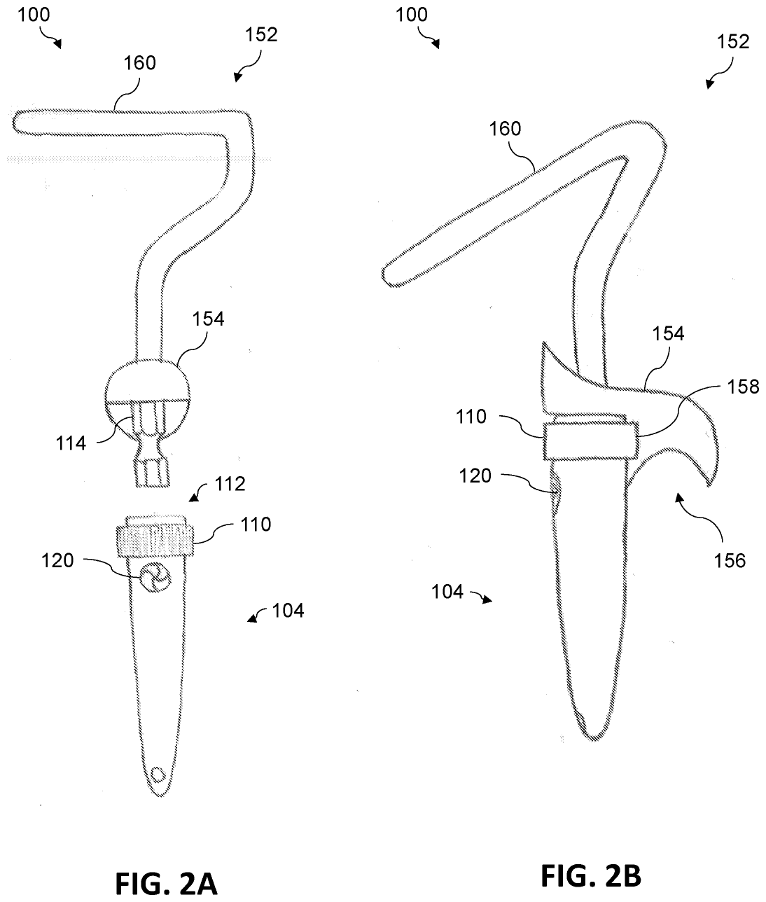

In addition to brushes, rollers can also be used with the interchangeable painting system. FIGS. 2A and 2B illustrate the interchangeable painting system 100 being used with a roller base 152. The roller base 152 allows various size rollers to be inserted on a shaft 160 of the roller base 152. For example, a 9 inch roller made of a wicking material suitable for painting can be slid over the shaft 160 and secured in place to the roller base 152. Various size rollers can also be used with the interchangeable painting system 100. For example, a 6 inch sausage roller (mini-roller) can be used with the interchangeable painting system 100. In some implementations, securing a roller to the shaft 160 is performed with a frictional sliding fit. Various rollers can be used with the interchangeable painting system 100 such as rollers from 4 inches wide to rollers 12 inches wide. In some implementations, a cage roller is used. In some implementations, a sausage roller is used which is built-into the roller base.

The releasable connection 118 of the roller base 152 to the paintbrush handle 104 is the same as the releasable connection 118 of the brush 102 to the paintbrush handle 104. In this implementation, the roller base 152 includes a projection 154 with a recess 156 for a painter's index finger to rest. Preferably, at least a portion of the surface rests against the painter's index finger for comfort and for control of the roller base 152 during painting.

FIG. 2B shows a side view of the roller base 152 attached to the paintbrush handle 104. The projection 154 includes a cut-out 158 for the collar 110 so that the collar 110 can freely spin without engaging the projection 154. The projection 154 is of circular cross-section (as observed in FIG. 2A), but in some implementations, other cross-sections are used.

The interchangeable painting system 100 is also compatible and additional brush sizes and various brush angles that are omitted for brevity. The interchangeable painting system 100 can be used with hundreds of different brush tips depending on application needs. For example, a professional painter might use three of four paint brushes during a day, but a canvass painter might use a hundred small brushes to paint a canvas. The interchangeable painting system 100 is adaptable to canvass paint brushes, foam brushes, and other brushes. The interchangeable painting system 100 is also adaptable to non-paint applications, such as sweeping, mopping, and dusting.

FIGS. 3A and 3B illustrate an extension handle 200 of the interchangeable painting system 100. The extension handle 200 includes a telescoping tube 202 (or extension pole) telescopically connected to the extension handle 200 and configured to slide within a cylindrical bore 204 of the extension handle 200. FIG. 3A shows the extension handle 200 with the telescoping tube 202 in a retracted position and FIG. 3B shows the extension handle 200 with the telescoping tube 202 in an extended position.

The telescoping tube 202 includes a latch 206 located at an end 208 of the telescoping tube 202. The latch 206 is configured to releasably engage with the detent 120 of the paintbrush handle 104 (e.g., the detent 120 as shown in FIG. 1A). A portion of the paintbrush handle 104 is configured to slide within a cylindrical bore 210 of the telescoping tube 202. When the paintbrush handle 104 is secured to the telescoping tube 202, via the latch 206, a portion of the paintbrush handle 104 is visible and projects out from an end of the telescoping tube 202 and a portion is contained within the telescoping tube 202. The latch 206 includes a spring-loaded button 230 biased to press the latch 206 against the detent 120 of the handle 104.

The extension handle 200 includes a latch 212 configured to releasably engage one or more openings 214a, 214b, 214c, 214d (collectively the openings 214) in the telescoping tube 202. The openings 214 are holes that pass through the telescoping tube 202. One of the openings 214 engage with the latch 212 such that a length that the telescoping tube 202 projects from the telescoping tube 202 is fixed. When the latch 212 is directly over one of the openings 214, the latch projects through a cover 216 and mechanically engages with an edge of the opening 214 to secure the telescoping tube 202 in that position.

A spring-loaded button 218 of the latch 212 is configured to slidably release the telescoping tube 202 from the extension handle 200 when pressed. For example, a painter presses the button 218 to release the telescoping tube 202 such that the latch 212 no longer projects into the opening 214 and no longer mechanically engages with the edge of the opening 214. The painter then pulls the telescoping tube 202 out from the cylindrical bore 204 to extend the telescoping tube 202. In the implementation shown, the telescoping tube 202 is extendable in one foot increments (i.e., the openings are places one foot apart along a longitudinal axis of the telescoping tube 202) with a total extended range of five feet, but telescoping tubes can be longer or shorter and include various incremental positions. For example, in some implementations, a ten foot telescoping tube is used with the interchangeable painting system 100.

The extension handle 200 includes a grip 222 operable to allow a user to orient a paint brush or roller of the interchangeable painting system 100 (e.g., the brush 102 or roller 202) for a painting application). At least a portion of the grip 222 is a soft foam material for comfort, but in some implementations, other materials such as rubber or plastic are used. The extension handle 200 includes a logo 224 in a central area 226. In some implementations, the extension handle 200 includes a spring configured to bias the telescoping tube 202 in the furthest extended position.

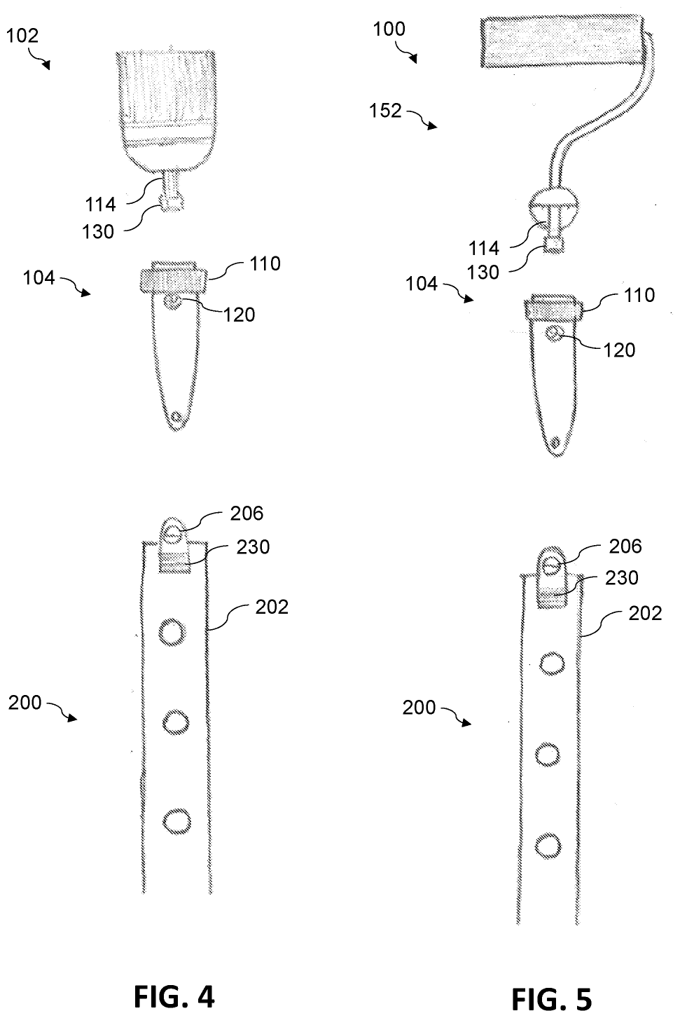

FIG. 4 illustrates the interchangeable painting system 100 where the extension handle 200, the paintbrush handle 104, and the brush 102 are used together. In this way, the interchangeable painting system 100 is considered a three-part system. The interchangeable painting system 100 can be assembled and disassembled in various ways. For example, a painter may attach the brush 102 to the paintbrush handle 104 for painting walls or cutting around trim, but may later need to paint hard-to-reach locations, such as ceilings. In this scenario, the painter may take the paintbrush handle 104 with the brush 102 attached and attach it to the extension handle 200. When the paintbrush handle 104 with the attached brush 102 is attached onto an end of the telescoping tube 202, the paintbrush handle 104 is slid into the cylindrical bore 204 of the telescoping tube 202. Once the paintbrush handle 104 is fully inserted, the latch 206 “snaps” into place on the detent 120 of the paintbrush handle 104 securing the paintbrush handle 104 to the telescoping tube 202.

FIG. 5 illustrates the interchangeable painting system 100 where the extension handle 200, the paintbrush handle 104, and the roller base 152 are used together. By way of example, the painter may need to switch from the brush 102 to the roller base 152 and may remove the brush 102 and attach the roller base 152. To remove the brush 102, the collar 110 on the end of the paintbrush handle 104 is rotates to release the engagement of the collet with the shaft 114 of the brush 102.

In some implementations, the shaft 114 includes a “T”-connector 130 that radially projects from the shaft 114. In some implementations, the “T”-connector 130 is be used in addition to the collet to secure the shaft 114 to the paintbrush handle 104. In some implementations, the “T”-connector 130 is be used to replace the collet to secure the shaft 114 to the paintbrush handle 104. In some implementations, engagement of the “T”-connector 130 is performed using quick-release connection where the collar 110 is configured to slide axially along the paintbrush handle 104. In this scenario, a painter would slide the collar 110 towards the brush 102 to release the engagement. When the painter releases the collar 110, a spring pushes the collar 110 back towards the body of the paintbrush handle 104. In this position the shaft 114 is secured. When attaching the shaft 114, the painter slides the shaft 114 into the paintbrush handle 104 where the “T”-connector engages a ramped portion of the paintbrush handle 104. After sliding past the ramp, the shaft 114 “snaps” into place and is secured.

While illustrated in an extended state in FIGS. 4 and 5, the interchangeable painting system 100 may also be used with the extension handle 200 in a compact state where the entire length of the telescoping tube 202 is contained within of the cylindrical bore 204 the extension handle 200. For example, this allows the painter to be able to paint smaller harder-to-reach locations such as cutting around a tall door with the interchangeable painting system 100 including the paintbrush handle 104, the brush 102, and the extension handle 200 and later extend the telescoping tube 202 to paint hard-to-reach locations.

FIG. 6 is an illustration of a paint container 300 compatible with the interchangeable painting system 100. The paint container 300 is typically constructed out of a thermoplastic material. The paint container 300 includes three reservoirs 302a, 302b, 302c (collectively the reservoirs 302). Each reservoir 302 holds a volume of paint of at least 0.5 pints of paint. Each reservoir 302 is fluidly isolated from each other so that different paint can be used in each reservoir 302. Each reservoir 302 includes a magnet 304a, 304b, 304c (collectively the magnets 304) embedded into a sidewall 306 of the respective reservoir 302. For example, in some implementations, the magnet 304 is located on the surface of the sidewall 306. In some implementations, the magnet 304 is underneath the surface of the sidewall 306 such that the magnets 304 are located in place during the molding process of the paint container 300. The magnets 304 are sized to releasably attach the brushes (e.g., brush 102 or roller base 152) to each respective reservoir 302.

For example, a painter would lower the paintbrush handle 104 into a reservoir 304, with the bristles 108 of the brush 102 facing down, and move the brush 102 in proximity of the magnet 304. The magnetic force by the magnet 304 with a magnetic ferrule 106 would cause the brush 102 to be attached to the magnet 304. In some implementations, the magnets 304 are configured to attach the entire paintbrush handle 104 to the reservoir 302. For example, at least one portion of the paintbrush handle 104 is magnetic to mate with the magnets 304. The painter could then detach the brush 102 from the paintbrush handle 104 and the brush 102 would remain in the reservoir 302. In some scenarios, the painter attaches the brush 102 without the paintbrush handle 104 to the magnet 304. For example, a magnetic ferrule 106 would attach directly to the magnet 304 without needing the paintbrush handle 104.

When the painter is ready to reattach the brush 102 to the paintbrush handle 104, the painter would insert the shaft 114 of the brush 102 into the paintbrush handle 104 and the collar 110 would be rotated so the collet rotationally engages the shaft 114. The painter would then lift the paintbrush handle 104 including the brush 102 away from the magnet 304 causing the magnet 304 to no longer exert sufficient force on the paintbrush handle 104 to secure the paintbrush handle 104 (and/or brush 102) to the magnet 304. The painter would then use the paintbrush handle 104 and the brush 102 as needed for painting applications or for cleaning.

The third reservoir 302c is sized to fit a 4 inch sausage roller. The minimum central width 308 of the third reservoir 302c is at least 4 inches wide. The third reservoir 302c includes a grate 310 for removing excess paint from the sausage roller. The grate 310 is similar to a washing board and includes many (e.g., six) small horizontal protrusions 312 for excess paint to seep out of the sausage roller and back into the third reservoir 302c. For example, when the roller is rolled back and forth on the grate 310, the roller spins and the excess paint is transferred into recesses between the horizontal protrusions 312 of the grate 310 and ultimately back into the third reservoir 302c. The sausage roller is also attachable to the sidewalls 306 of the reservoirs 302 using magnets 304 within the sausage roller.

The paint container 300 includes a handle 314 for holding the paint container 300. The handle 314 is located on the back 316 of the paint container 300 and is sufficiency sized to allow a painter to insert four fingers through an opening 318 and a thumb on the top of the paint container 300. The painters palm would face towards the back 316 of the paint container 300. The handle 314 is resilient and constructed of a rubber material for mating with rungs of a ladder. The handle 314 is arranged in a closed loop. When a painters hand is inserted into the handle 314, the rubber material forms a tight, frictional fit around the painter's hand. In some implementations, a rubber strap is included with the paint container 300 for use as a supplemental handle.

In some implementations, the interchangeable painting system 100 is also provided as a kit or package that includes enough equipment for the painter to complete an entire painting job. For example, an interchangeable painting kit can include one paint container 300 with three reservoirs 302, where a first reservoir 302a comes with a 2 inch angled edge brush, a second reservoir 302b comes with a 3.5 inch flat edge brush, and a third reservoir 302c comes with a 4 in roller. The interchangeable painting kit can also include one extension handle 200.

The interchangeable painting system is also part of a recycling program. The recycling program provides an incentive for painters to recycle their old and broken painting equipment and minimizes waste in landfills. In addition, since the brushes 102 are detachable from the paintbrush handle 104, there is no longer a need to dispose of the paintbrush handle 104 at the brush's 102 end of life.

For example, when a painter subscribes to the recycling program, the painter will be expected to turn-in or trade-in their old painting equipment, where the old painting equipment can include components of the interchangeable painting system 100 or other painting equipment. In exchange for subscribing, the painter will receive discounts on new or refurbished components of the interchangeable painting system 100. For example, a painter could buy a new brush 102 for the interchangeable painting system 100 at a 50% discount when the painter trades-in two or more older brushes. In another example, the painter could by a refurbished extension handle 200 at a 75% discount when the painter turns in a broken extension handle 200 of the interchangeable painting system 100.

A number of embodiments of the systems and methods have been described. Nevertheless, it will be understood that various modifications may be made without departing from the spirit and scope of this disclosure. Accordingly, other embodiments are within the scope of the following claims.

What is claimed is:

1. An interchangeable painting system comprising:
a painting object comprising a shaft and at least part of the painting object is configured to apply paint to a surface;
a handle comprising:
a body with a receptacle that is configured to receive the shaft of the painting object; and
a latch attached to the body and configured to reversibly engage the shaft of the painting object such that the painting object is secured to the handle when the latch is in a first position and released from the handle when the latch is in a second position.

2. The interchangeable painting system of claim 1, wherein the latch comprises a collet configured to radially engage the shaft for securing the painting object in the first position.

3. The interchangeable painting system of claim 2, wherein the collet is engagable by rotating a collar of the handle in a first rotational direction and releasable by rotating the collar of the handle in a second rotational direction, the second rotational direction being opposite to the first rotational direction.

4. The interchangeable painting system of claim 1, wherein the latch comprises a ramped portion to radially engage a T-connector of the shaft for securing the painting object in the first position.

5. The interchangeable painting system of claim 4, wherein the T-connector is engagable by sliding a collar of the handle along a first longitudinal direction and releasable by sliding a collar of the handle along a second longitudinal direction, the second longitudinal direction being opposite to the first longitudinal direction.

6. The interchangeable painting system of claim 1, wherein the handle further comprises a spring to bias the painting object in a released state from the handle.

7. The interchangeable painting system of claim 1, wherein the receptacle is located at an end of the handle and the receptacle is concentric with the handle.

8. The interchangeable painting system of claim 1, wherein the handle further comprises a detent configured to releasably engage with a latch of an extension handle such that the detent is engaged when the latch is in a first position and released when the latch is in a second position.

9. The interchangeable painting system of claim 8, wherein the latch is spring-loaded such that the latch is biased in the first position.

10. The interchangeable painting system of claim 8, wherein the handle is configured to slide within a cylindrical bore of an extension handle such that the handle is covered by the extension handle when the handle is engaged with the extension handle.

11. The interchangeable painting system of claim 8, wherein the extension handle comprises a telescoping tube telescopically connected to the extension handle and the latch is located at a first end of the telescoping tube.

12. The interchangeable painting system of claim 1, wherein the painting object is a brush comprising a plurality of resilient bristles suitable for painting.

13. The interchangeable painting system of claim 1, wherein the painting object is a roller comprises a wicking material suitable for painting.

14. The interchangeable painting system of claim 1, wherein the painting object comprises a magnet configured to magnetically attach the handle to a paint container.

15. The interchangeable painting system of claim 1, further comprising a paint container with at least one reservoir configured to accept at least a portion of the painting object and hold a volume of paint.

16. The interchangeable painting system of claim 15, wherein the at least one reservoir comprises a magnet within a sidewall of the at least one reservoir.

17. The interchangeable painting system of claim 16, wherein the magnet is configured to magnetically attach the painting object to the paint container.

18. The interchangeable painting system of claim 15, wherein the at least one reservoir of the paint container comprises a magnet configured to magnetically attach the handle to the paint container.

19. The interchangeable painting system of claim 15, wherein the paint container comprises a grate for removing excess paint from the painting object.

20. The interchangeable painting system of claim 15, wherein the at least one reservoir is three reservoirs.
